(19) United States
(12) Patent Application Publication
(10) Pub. No.: US 2025/0092817 A1
(43) Pub. Date: Mar. 20, 2025

(54) PISTON FOR DIESEL ENGINES WITH OPTIMIZED COMBUSTION CHAMBER

(71) Applicant: Dumarey Automotive Italia S.p.A., Torino (IT)

(72) Inventors: Francesco Concetto Pesce, Torino (IT); Alberto Lorenzo Vassallo, Torino (IT); Vincenzo Ottria, Torino (IT); Fabio Numidi, Torino (IT); Vincenzo Pezza, Torino (IT)

(73) Assignee: Dumarey Automotive Italia S.p.A., Torino (IT)

(21) Appl. No.: 18/727,688

(22) PCT Filed: Jan. 13, 2023
(86) PCT No.: PCT/IB2023/050312

§ 371 Date: Jul. 10, 2024

(30) Foreign Application Priority Data
Jan. 14, 2022 (IT) 102022000000536

(51) Int. Cl. F02B 23/06

(52) U.S. Cl. CPC F02B 23/0672; F02B 23/0693

(57) ABSTRACT

A piston for Diesel engines having a combustion chamber with an optimized design to improve engine performances and to reduce engine emission.

The combustion chamber is provided by a specific profile and, in particular, by its central region with double inclination and by the tapered lateral step. This particular geometry of the combustion chamber aims to improve smoke formation and its oxidation, emissions at the engine outlet, thermal efficiency and carbon dioxide emissions.

Since the main characteristics of the combustion chamber can be parameterized, this combustion chamber can be applied to different types of diesel engines with any displacement, bore/stroke ratio, rotation speed and application.

### BACKGROUND OF THE INVENTION

### 1. Field of the Invention

The present invention relates to a piston for Diesel cycle engines, the piston having a combustion chamber with an optimized design to improve engine performances and to reduce engine emission.

### 2. Brief Description of the Prior Art

As is known from diesel engine technology, the regulations on the containment of exhaust emissions require continuous improvements in the design of the engine in order to reduce the emissions themselves and exceed ever more stringent standards.

For example, the air intake system design provides for the supply of increasingly high rates of cooled EGR (exhaust gas recirculation), thereby reducing emissions of nitrogen oxides (NOx); at the same time, since this countermeasure implies an increase in smoke emissions, fuel injection systems must be optimized to reduce smoke production. In addition, the combined emissions of smoke and NOx still need to be treated in exhaust gas treatment systems in order to reduce tailpipe emissions from diesel engines. Exhaust aftertreatment systems, however, are very expensive and therefore not the most desirable means of achieving emission reductions.

Conversely, advances in combustion system design could reduce emissions by minimizing the need for exhaust after-treatment systems.

Furthermore, the fuel economy, exhaust emissions and performance of diesel combustion systems are strongly influenced by the design of the engine piston, in particular the design of the combustion chamber machined into the piston ceiling, as well as the choice of fuel injection and the air treatment equipment (e.g., turbocharger, EGR system, etc.). Therefore, improvements in diesel engine piston design could advantageously lead to lower emissions without significant cost increases.

There is therefore a need to define a piston for Diesel engines and in particular its combustion chamber, so that the combustion chamber be always optimized depending on the specific application.

### SUMMARY OF THE INVENTION

The aim of the present invention is to realize a piston for Diesel engines provided with an innovative combustion chamber.

The combustion chamber according to the present invention is characterized by its specific profile and, in particular, by its central region with double inclination and by the tapered lateral step. This particular geometry of the combustion chamber aims to improve smoke formation and its oxidation, emissions at the engine outlet, thermal efficiency and carbon dioxide (CO2) emissions.

The invention is applicable to various types of diesel engines with any displacement, bore/stroke ratio, rotational speed and application.

In fact, by varying these design parameters, the characteristics of the combustion chamber can be optimized accordingly.

Therefore, according to an aspect of the present invention a piston for Diesel engine is provided, the piston having the characteristics set forth in the independent product claim appended hereto.

Further preferred and/or particularly advantageous embodiments of the invention are described according to the features set forth in the attached dependent claims.

### BRIEF DESCRIPTION OF THE DRAWINGS

The invention will now be described with reference to the appended drawings, which illustrate a non-limiting example embodiment, wherein:

FIG. 1 schematically shows a piston having a combustion chamber arranged inside a cylinder bore of an engine, according to an aspect of the present invention,

FIG. 2 is a cross-sectional view of a combustion chamber obtained between the cylinder and the piston of FIG. 1, in a first embodiment of the present invention,

FIG. 3 is a cross-sectional view of a combustion chamber obtained between the cylinder and the piston of FIG. 1, in a second embodiment of the present invention, and

FIG. 4 illustrates some performance results of some embodiments of the combustion chamber according to the present invention, obtained with simulation methods.

### DETAILED DESCRIPTION OF THE PREFERRED EMBODIMENTS

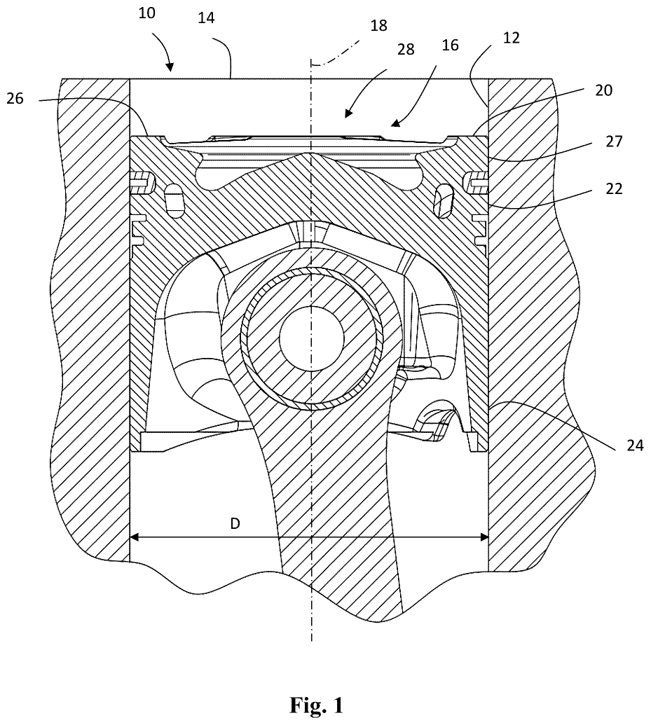

With reference to FIG. 1, the number 10 generally indicates a Diesel engine comprising a cylinder 12, having a closed upper end 14.

A piston 16 having an external diameter D moves with a reciprocating motion in the cylinder 12 along a central axis 18. Obviously, the piston 16 has an external diameter D suitable for coupling with a cylinder 12 of corresponding bore according to known coupling criteria of internal combustion engines.

The piston 16 generally has a cylindrical shape centered on the axis 18 and comprises a flat-running ceiling 20, an annular head 22 with grooves for piston rings and a skirt 24 extending axially from the annular head 22.

The ceiling 20 has a substantially flat upper edge 26 which extends inwards from a side wall 27 and which generically defines the upper part of the piston 16.

A circular combustion chamber 28 is recessed into the ceiling 20 within the upper edge 26 and centered on the central axis 18.

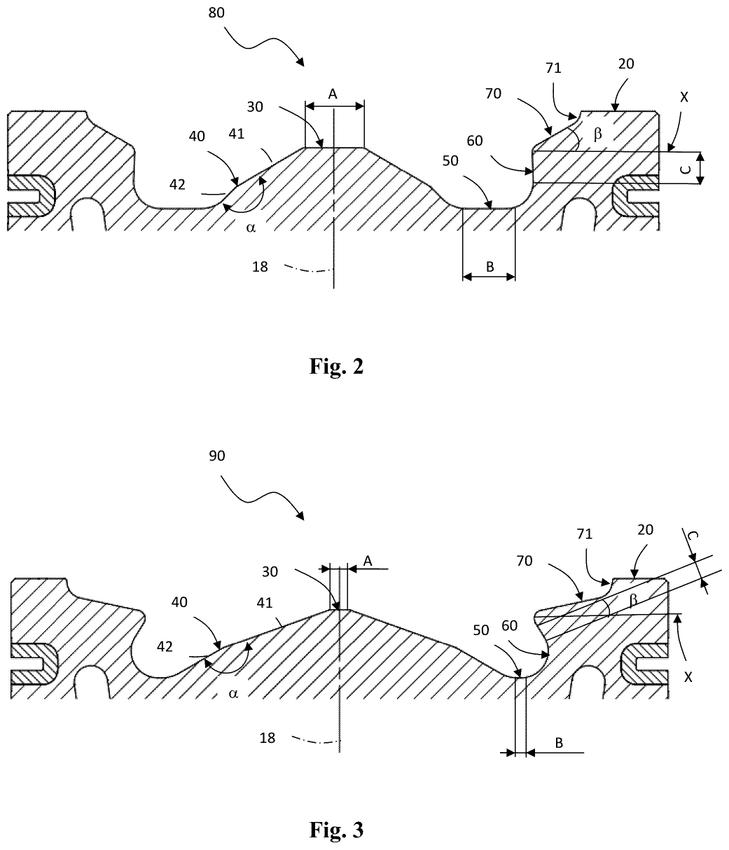

According to the present invention, the innovative combustion chamber is illustrated in two possible embodiments in FIGS. 2 and 3. The new combustion chamber can be designed in the two embodiments or in numerous other embodiments, simply by varying the parameters geometric controls which will be described below within predefined intervals.

In particular, according to a first embodiment shown in FIG. 2, the combustion chamber 80 assumes a substantially squared shape and will also be referred to hereinafter as “Squared”.

In a second embodiment illustrated in FIG. 3, the combustion chamber 90 assumes a substantially rounded shape and will also be referred to as “Rounded” in the following.

As will be seen, these two embodiments are achieved by setting almost all the characteristic geometric parameters to the extreme. In particular, assuming the maximum values of these geometric parameters, the combustion chamber 80 will be obtained, i.e., the “Squared” type. Conversely, assuming the minimum values of the same geometric parameters, the combustion chamber 90 will be obtained, i.e., the “Rounded” type.

As already mentioned, numerous intermediate configurations are possible, by varying one or more of the characteristic geometric parameters within predetermined intervals and each combustion chamber variant thus obtained can be used for one or more specific applications.

The two embodiments of FIGS. 2 and 3 having the geometrical parameters having an extreme degree will now be described in greater detail, it being understood that what will be said is also perfectly applicable to all the intermediate configurations that can be achieved.

The geometric parameters which uniquely characterize the combustion chamber according to the present invention are illustrated in both FIGS. 2 and 3.

A first geometric parameter is a central dome 30 with a flat top which favors the reversal of motion of the fuel spray and allows an effective oxidation reaction in the final phase of the expansion due to the fact that the central wall of the combustion chamber is between the warmest areas. To guarantee these benefits, the diametral length A of the top of the dome 30, compared to the external diameter D of the piston 16, can vary between 0.012 and 0.042, where the ratio 0.012 defines the combustion chamber 90 or “rounded” while the ratio 0.042 defines the combustion chamber 80 or “squared”. In particular, for an engine application whose piston has an external diameter of 84 mm, the diametral length A of the top of the dome 30 may vary between 1 mm (“rounded”) and 3.6 mm (“squared”).

A second geometric parameter is the side wall 40 of the dome 30, characterized by a double slope. In other words, the side wall 40 is formed by a first portion 41 close to the top of the dome 30 and by a second portion 42, distal to the top of the dome 30. The two side wall portions have two different inclinations with respect to the axis central 18, in particular the first portion 41 is more inclined than the second portion 42 and therefore the entire side wall 40 assumes a double slope with respect to the central axis 18. This double slope favors the generation of local turbulence and the rapid mixing of the charge. In particular, this geometric parameter can be measured as the angle α between the first side wall portion 41 and the second side wall portion 42. The values that the angle α can assume, to guarantee the generation of local turbulence, are between 165° and 180°. Both for the combustion chamber 80 and for the combustion chamber 90 of FIGS. 2 and 3, the value of the angle α is equally included within this range.

A third geometrical parameter is the flat bottom 50. This feature favors the breaking and mixing of the secondary sprays thanks to the generation of local mixing phenomena. To guarantee the aforementioned benefit, the linear dimension B of the flat bottom 50, compared to the external diameter D of the piston 16, can vary between 0.006 and 0.06, in which the ratio 0.006 defines the combustion chamber 90 or “rounded” while the 0.06 ratio defines the combustion chamber 80 or “squared”. In particular, for motor applications whose piston has an external diameter of 84 mm, the linear dimension B of the flat bottom 50 assumes values between 0.5 mm (“rounded”) and 5 mm (“squared”).

A fourth geometric parameter is a lateral wall 60 that is radially external and flat and parallel to the central axis 18. In this way, the breaking of the secondary sprays is favored thanks to the orthogonal impact of the fuel with respect to the lateral wall 60. To guarantee the aforementioned benefit, the linear dimension C of the lateral wall 60, compared to the external diameter D of the piston 16, can vary between 0.024 and 0.042, in which the ratio 0.024 defines the combustion chamber 90 or “rounded” while the ratio 0.042 defines the combustion chamber 80 or “squared”. In particular, for motor applications whose piston has an external diameter of 84 mm, the linear dimension C of the lateral wall 60 can assume values between 2 mm (“rounded”) and 3.5 mm (“squared”).

Finally, a fifth geometrical parameter is the tapered step 70, connecting the lateral wall 60 and the ceiling 20 of the piston 16, and provided with a wall portion 71 with the function of stopping the flame. This tapered step 70 favors a high use of air in conditions of high power avoiding an almost proportional formation of smoke thanks to the wall portion 71 having the function of stopping the flame and being almost vertical. The tapered step 70 also provides a smooth transition between the lateral wall 60 of the combustion chamber and the outer wall (i.e., the ceiling 20 of the piston 16) of the combustion chamber as the load increases. To guarantee the benefits described above, the angle β of inclination of the tapered step 70 with respect to a horizontal plane X perpendicular to the central axis 18 can vary between 20° (“rounded”) and 30° (“squared”).

As has been said, the embodiments illustrated in FIGS. 2 and 3 are achieved by setting almost all the geometric parameters that define the innovative combustion chamber to their limit values. Assuming the maximum values of these geometric parameters, the combustion chamber 80 will be obtained, i.e., the “Squared” type. Conversely, assuming the minimum values of the same geometric parameters, the combustion chamber 90 will be obtained, i.e., the “Rounded” type. The only exception is the parameter α, an angle which defines the double slope of the side wall 40 with respect to the central axis 18 or, more precisely, the angle between the first side wall portion 41 and the second side wall portion 42.

The following table summarizes the characteristic values of the geometric parameters mentioned above for the engine application having a piston with an external diameter equal to 84 mm.

TABLE 1

| | |
|---|---|
| Squared | Rounded |

| | | | | |
|---|---|---|---|---|
| Top of the dome (A) | 3.6 | mm | 1 | mm |

| | | |
|---|---|---|
| Side wall of the dome (α) | 165°-180° | 165°-180° |

| | | | | |
|---|---|---|---|---|
| Flat bottom (B) | 5 | mm | 0.5 | mm |
| Lateral wall (C) | 3.5 | mm | 2 | mm |

| | | |
|---|---|---|
| Tapered step (β) | 30° | 20° |

La camera di combustione 80, “Squared”, trova vantaggioso utilizzo nelle applicazioni pesanti (cosiddette “heavy-duty”), ad esempio per motori Diesel aventi cilindrata unitaria superiore a 1000 cc, ad alta efficienza, provvisti di condotti ad alto flusso, e con turbolenza molto bassa. Si tratta inoltre di una camera di combustione facilmente ottenibile per forgiatura.

Al contrario, la camera di combustione 90, “Rounded”, trova vantaggioso utilizzo nelle applicazioni leggere (“light-duty”), ad esempio per motori Diesel aventi cilindrata unitaria inferiore a circa 1000 cc, provvisti di condotti a media turbolenza e aventi il requisito di bassissime emissioni.

Con riferimento alla figura 4, al fine di comprovare la bontb delle scelte progettuali cosi come sopra descritte, sono state effettuate delle simulazioni utilizzando un codice tridimensionale di fluidodinamica computazionale opportunamente correlato con dati sperimentali a disposizione, per ottenere la massima accuratezza nelle predizioni. E stata considerata una camera di combustione standard (baseline) il cui pistone ha sempre un diametro esterno pari a 84 mm e i cui valori caratteristici sono riportati nella seguente tabella.

TABLE 2

| | Baseline |
|---|---|
| Top of the dome (A) | 1 mm |
| Side wall of the dome (α) | 180° |
| Flat bottom (B) | 0 mm |
| Lateral wall (C) | 0 mm |
| Tapered step (β) | 0° |

As can be seen from the table above, the standard combustion chamber (baseline) is not characterized by the five parameters that define the present invention, on the contrary the flat bottom, the vertical lateral wall (that is, parallel to the cylinder axis) and the step tapered are not entirely present.

With respect to this combustion chamber, five combustion chamber variants were compared (Variant 1, . . . , Variant 5) obtained using the design criteria described, i.e., with values of the characteristic parameters within the ranges defined above.

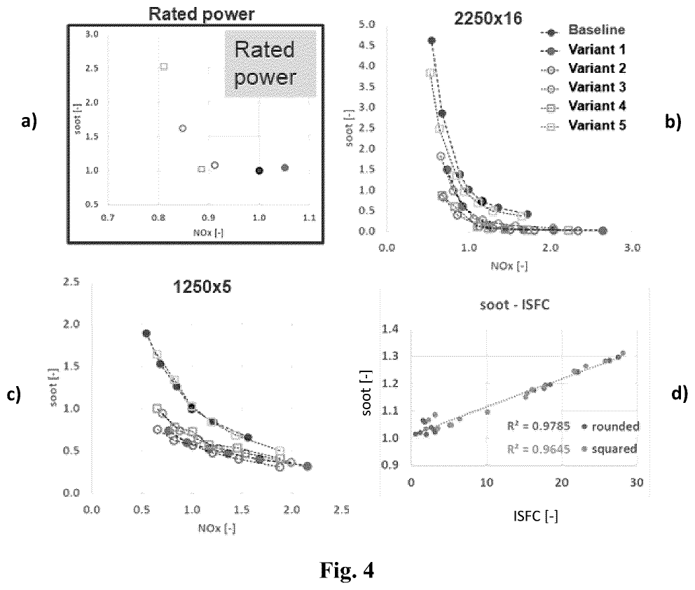

In particular, graphs a), b), c) of FIG. 4 show for each of the five combustion chamber variants:
a) the smoke values (“soot”, y axis) as a function of nitrogen oxides (NOx, x axis) in nominal power conditions (“Rated power”);
b) the smoke values (“soot”, y axis) as a function of nitrogen oxides (NOx, x axis) at the point 2250×16, where 2250 (rpm) is the engine rotation speed and 16 (bar) is the average effective pressure;
c) the smoke values (“soot”, y axis) as a function of nitrogen oxides (NOx, x axis) at the 1250×5 point, where 1250 (rpm) is the engine rotation speed and 5 (bar) is the average effective pressure.

Graph d), on the other hand, shows the smoke values (“soot”, y axis) as a function of specific consumption (ISFC, x axis) for the two combustion chambers whose geometric parameters have extreme values, i.e., the variants previously defined such as “squared” (FIG. 2) and “rounded” (FIG. 3). The same graph also shows the correlation line of these values, which shows high values of R2, the correlation coefficient.

Graphs a) to c) show the dimensionless values of smoke as a function of nitrogen oxides. In particular, the baseline obtained with the standard combustion chamber was plotted, and the NOx and smoke values were divided by the corresponding baseline value (red dot) at the different key points.

The variations of the geometric parameters within each family of combustion chambers create some small differences in terms of smoke: in all cases the improvement compared to the baseline is significant both in the partial load area and in rated power one.

Also in graph d) the values shown have been dimensionless. Thanks to the good correlation between specific consumption and smoke, a benefit is also expected in fuel consumption and, consequently, in CO2 emissions.

On the basis of the present description, supported by the results of the simulations carried out, the combustion chamber according to the present invention therefore allows:
to improve the formation of smoke and its oxidation and the thermal efficiency;
to reduce the emissions at the engine outlet, and the carbon dioxide (CO2) emissions.

Furthermore, being able to parameterize its main characteristics, this combustion chamber can be applied to different types of diesel engines with any displacement, bore/stroke ratio, rotation speed and application.

In addition to the form of the invention as described above, it must be understood that there are numerous other variants. It must also be understood that these forms of embodiment are merely illustrative and do not limit either the scope of the invention, its applications or its possible configurations. On the contrary, although the above description allows the skilled person to implement the present invention at least according to one exemplary form of embodiment thereof, it should be understood that many variations of the described components are possible, without thereby departing from the scope of the invention as defined in the appended claims, which are interpreted literally and/or according to their legal equivalents.

1. A piston (16) suitable for a Diesel engine (10), the piston comprising a flat ceiling (20), an annular head (22), a skirt (24) extending axially from the annular head (22) and a circular combustion chamber (28, 80, 90) embedded in the ceiling (20) and centered on a central axis (18),
the combustion chamber (28, 80, 90) comprises:
a central dome (30) with a flat top,
a side wall (40) of the dome (30), having a double slope with respect to the central axis (18),
a flat bottom (50),
a lateral wall (60) radially external, flat and parallel to the central axis (18), and
a tapered step (70) for connection between the radially external lateral wall (60) and the ceiling (20) of the piston (16).

2. The piston (16) according to claim 1, wherein the side wall (40) is formed by a first portion (41) close to the top of the dome (30) and by a second portion (42), distal with respect to the top of the dome (30) and the first portion (41) is more inclined than the second portion (42) with respect to the central axis (18).

3. The piston (16) according to claim 1, in which the tapered step (70) is provided with a wall portion (71) having the function of combustion flame stopper.

4. The piston (16) according to claim 1, in which the ratio between a diametral length (A) of the top of the dome (30) and an external diameter (D) of the piston (16) is comprised in a range between 0.012 and 0.042.

5. The piston (16) according to claim 2, wherein an angle (a) between the first portion (41) of the side wall (40) of the dome (30) and the second portion (42) of the side wall (40) of the dome (30) is included in an interval between 165° and 180°.

6. The piston (16) according to claim 1, wherein the ratio between a linear dimension (B) of the flat bottom (50) and the external diameter (D) of the piston (16) is in a range between 0.006 and 0.06.

7. The piston (16) according to claim 1, wherein the ratio between a linear dimension (C) of the radially external lateral wall (60) and the external diameter (D) of the piston (16) is in a range between 0.024 and 0.042.

8. The piston (16) according to claim 1, in which an angle (p) of inclination of the tapered step (70) with respect to a horizontal plane (X) perpendicular to the central axis (18) is in a range between 20° and 30°.

9. The piston (16) according to claim 8, wherein in the combustion chamber (80):
the ratio between the diametrical length (A) of the top of the dome (30) and the external diameter (D) of the piston (16) is equal to 0.042,
the ratio between the linear dimension (B) of the flat bottom (50) and the external diameter (D) of the piston (16) is equal to 0.06,
the ratio between the linear dimension (C) of the radially external lateral wall (60) and the external diameter (D) of the piston (16) is equal to 0.042, and
the angle (p) of inclination of the tapered step (70) is equal to 30°.

10. The piston (16) according to claim 8, wherein in the combustion chamber (90):
the ratio between the diametrical length (A) of the top of the dome (30) and the external diameter (D) of the piston (16) is equal to 0.012,
the ratio between the linear dimension (B) of the flat bottom (50) and the external diameter (D) of the piston (16) is equal to 0.006,
the ratio between the linear dimension (C) of the radially external lateral wall (60) and the external diameter (D) of the piston (16) is equal to 0.024, and
the angle (p) of inclination of the tapered step (70) is equal to 20°.
